(19) United States
(12) Patent Application Publication
(10) Pub. No.: US 2014/0313887 A1
(43) Pub. Date: Oct. 23, 2014

(54) COMMUNICATION NODE HAVING TRAFFIC OPTIMIZATION CAPABILITY AND METHOD FOR OPTIMIZING TRAFFIC IN COMMUNICATION NODE

(71) Applicant: Electronics and Telecommunications Research Institute, Daejeon (KR)

(72) Inventors: Young Min KIM, Daejeon (KR); Boo Geum JUNG, Daejeon (KR); Hea Sook PARK, Daejeon (KR); Byungjun AHN, Daejeon (KR); Kyeong Ho LEE, Daejeon (KR)

(73) Assignee: Electronics and Telecommunications Research Institute, Daejeon (KR)

(21) Appl. No.: 14/089,018

(22) Filed: Nov. 25, 2013

(30) Foreign Application Priority Data
Apr. 19, 2013 (KR) 10-2013-0043348

(51) Int. Cl. H04W 28/06

(52) U.S. Cl. CPC H04W 28/06
USPC 370/230

(57) ABSTRACT

The present invention provides an apparatus for optimizing traffic of packets produced in a user terminal and a remote node with a WAN link between the user terminal and the remote node. The apparatus includes a flow information table configured to have identification information about the respective packets that are managed in the apparatus, a packet processing module configured to analyze the packets to determine whether the respective packets are identified in the flow information table, and an optimization module configured to optimize the packets in compliance with the optimization option specified in the respective identified packets.

### RELATED APPLICATIONS

This application claims the benefit of Korean Patent Application No. 10-2013-0043348, filed on Apr. 19, 2013, which is hereby incorporated by reference as if fully set forth herein.

### FIELD OF THE INVENTION

The present invention relates to a WAN (Wide Area Network) optimization technique to keep a high quality multimedia service efficiently in a WAN environment with a limited frequency band and high RTT (Round-Trip Time). More particularly, the present invention relates to a communication node for providing an integrated traffic optimization solution to communication terminals without an additional equipment installation and a method for optimizing packet traffic on the communication node.

### BACKGROUND OF THE INVENTION

As well known in the art, a communication system may be classified into a LAN (Local Area Network) system for a local area communication and a WAN (Wide Area Network) system for remote telecommunication. The WAN system is an extensive network formed by interconnecting local area networks such as LAN and metropolitan area networks such as MAN (Metropolitan Area Network) that are dispersed in large areas, using a communication line service such as private lines, packet-switched networks, ISDN (Integrated Services Digital Network) and the like provided by a public telecommunication operator.

The LAN services a high-quality transmission at high speed in a relatively narrow range, and the WAN has an advantage that can provide services to a wide area, but it has a disadvantage of somewhat poor transmission quality and transmission rate.

On the other hand, a section in which user's PCs or network equipment are connected is called a LAN link, and a section that connects between a LAN and a LAN to configure a remote network is called a WAN link.

A chronic problem with the WAN link includes, 1) significant difference of bandwidth between the LAN link with a bandwidth of several tens of GHz and the WAN link with a bandwidth of several tens of MHz, 2) a high latency of the WAN link (RTT (Round-Trip Time)), and 3) reduction in bandwidth usage efficiency of the WAN link by TCP Slow Start. These problems result in a reduction in the quality of business services over the WAN link eventually.

WAN optimization techniques have been proposed to solve the above problems. A WAN optimization technique installs a separate equipment, for example, a WAN appliance, for optimization of a WAN link between a communication terminal such as a computer for work or a business user who accesses a branch network of the enterprise and a data center of the enterprise network at an incoming end of an enterprise network between a head office and a branch office and provides WAN optimization techniques such as an OS (Object Caching), BC (Byte Caching), CP (Compression and BM (Bandwidth Management, PO (Protocol Optimization). According to these optimization technologies, it is possible to reduce the WAN traffic between the data center in the head office and the business users in the branch office and to significantly increase the satisfaction of business services between the data center and the business users.

However, the WAN optimization techniques, which have been developed to date, have been designed to work with on an appliance base. Further, in order to achieve the WAN optimization, a WAN optimization technique has limitations in some phases that a separate device for WAN optimization should be always installed in the incoming end of the network and integration solution that takes into account to some aspects such as security issues and QoS, which might occur due to optimization and application acceleration, and network viability issues is insufficient. Foremost, the WAN optimization techniques are developed only for an interest group such as corporate networks and therefore have a demerit that the market is limited to the corporate networks.

Looking at the findings of the IDC or Gartner of the market trends research firm, it is expected that video traffic through the smart device hence will exponentially increase to account for 61% of the total traffic. It is estimated that the explosive increase in such traffic not only causes a sharp increase in WAN traffic, but also leads to a sharp decline in quality of service experience of smart device users. An attempt to improve the quality of service experience through the network expansion may be a simple solution to that. However, the network expansion is a temporary alternative and requires further expansion cost. In addition, in view of a fact that deterioration in performance over the WAN link is caused by 1) lack of bandwidth as well as, 2) a high RTT over the WAN link and 3) a reduction in bandwidth usage efficiency by the TCP protocol, it is expected that improvement of quality of service experience associated with the expansion is not so large. (According to the white paper, available from Riberbed Inc., a vendor of WAN optimization equipments, it is reported that, on the network having an end-to-end delay of 100 ms, TCP protocol can use only 10% of the available bandwidth). In other words, as long as the WAN optimization technique does not solve the most fundamental three problems that cause the reduction in performance in the WAN link as set forth above, it cannot be expected to improve the quality of service experience of the smart device users.

As another solution, it is proposed to apply to the smart devices the WAN optimization technique based on an appliance that has been exclusively utilized in the enterprise networks. When utilizing this proposal, it is possible to successfully improve quality of service experience of the smart device users. However, as mentioned above, it is required additionally to install an expensive WAN optimization appliance in all terminals such as the smart devices, and it is difficult to provide the integrated solutions such as security issues and QoS that are caused by the optimization.

### SUMMARY OF THE INVENTION

In view of the above, the present invention provides a communication node for providing a traffic optimization solution to the user's communication terminals without installing an appliance-based WAN optimization technique in the respective communication terminals, and a method for optimizing traffic for use in the communication node.

In accordance with an aspect of an exemplary embodiment of the present invention, there is provided an apparatus for optimizing traffic of packets produced in a user terminal and a remote node with a WAN link between the user terminal and the remote node, the apparatus comprising: a flow information table configured to have identification information about the respective packets that are managed in the apparatus and specify an optimization option to be optionally applied to the respective packets; a packet processing module configured to analyze the packets to determine whether the respective packets are identified in the flow information table; and an optimization module configured to optimize the packets in compliance with the optimization option specified in the respective identified packets.

In the exemplary embodiment, wherein the packet processing module comprises a packet classification unit configured to inspect a header of the packets to classify the packets.

In the exemplary embodiment, wherein the packet classification unit comprises a DPI (Deep Packet Inspection) unit and is configured to identify a flow based on at least 5-tuple.

In the exemplary embodiment, wherein the flow information table is configured to contain information on the flow managed by the apparatus in the form of a table; and wherein the information on the flow comprises information about a flow identification ID, a service type of the packets and an optimization option that is applied to the packets.

In the exemplary embodiment, wherein the optimization option comprises an OC (Object Caching), BC (Byte Caching), CP (Compression), BM (Bandwidth Management) or a combination thereof.

In the exemplary embodiment, wherein the optimization apparatus is incorporated into a router.

In accordance with another aspect of an exemplary embodiment of the present invention, there is provided a method for optimizing traffic of packets produced in a user terminal and a remote node with a WAN link between the user terminal and the remote node, the method comprising: analyzing the packets to determine whether the packets are managed in the optimization apparatus; and determining, when it is determined that the packets are managed by the optimization apparatus, whether an optimization option is specified in the managed packets; and optimizing the packets in compliance with the optimization option specified in the managed packet.

In the exemplary embodiment, wherein the packets are analyzed by a DPI (Deep Packet Inspection) scheme.

In the exemplary embodiment, wherein the DPI scheme is configured to identify a flow based on at least 5-tuple.

In the exemplary embodiment, wherein said optimizing the packets comprises: applying an OC (Object Caching), BC (Byte Caching), CP (Compression), BM (Bandwidth Management) or a combination thereof to the managed packets.

### BRIEF DESCRIPTION OF THE DRAWINGS

The above and other objects and features of the present invention will become apparent from the following description of the embodiments given in conjunction with the accompanying drawings, in which:

FIG. 1 is a diagram of a network system to which a traffic optimization solution is applicable in accordance with an embodiment of the present invention;

FIG. 2 is a block diagram of a traffic optimization apparatus installed in a communication node shown in FIG. 1 in accordance with an embodiment of the present invention; and

FIG. 3 is a flowchart illustrating a method for optimizing traffic performed in the communication node shown in FIG. 1 in accordance with an embodiment of the present invention.

### DETAILED DESCRIPTION OF THE EMBODIMENTS

Hereinafter, the embodiments of the present invention will be described in detail with reference to the accompanying drawings so that a person having ordinary skill in the art can easily implement the embodiments of the present invention.

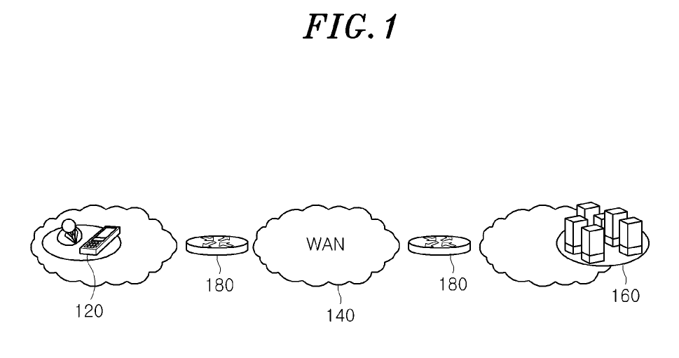

FIG. 1 is a diagram of a network system to which a traffic optimization solution is applicable in accordance with an embodiment of the present invention.

Referring to FIG. 1, a network system includes a user terminal 120 connected to a local network, a remote node 160 connected to a local network in a remote location, and communication nodes 180 that optimize packets produced at the user terminal 120 and the remote node 160 with a WAN link 140 between the user terminal 120 and the remote node 160.

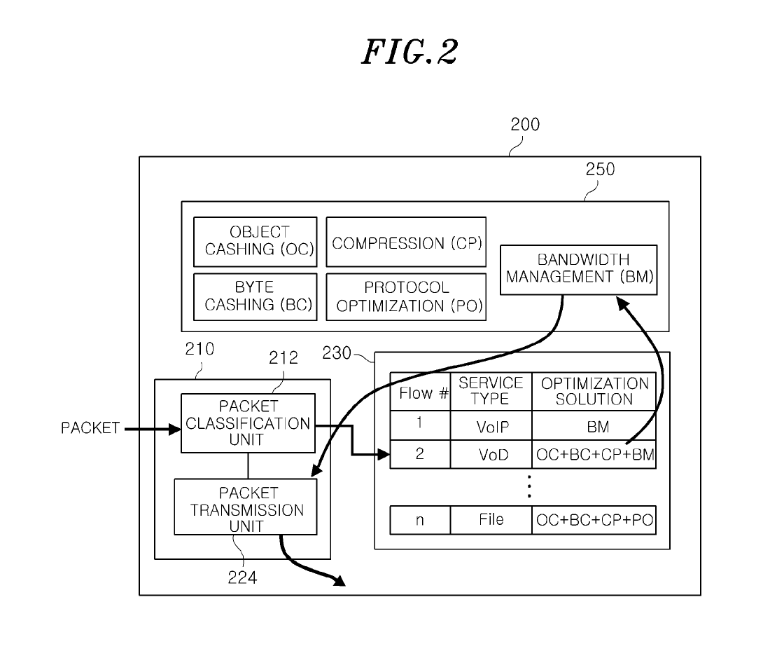

The user terminal 120 may be, for example, smart devices such as smart phones, tablet PCs and the like which are connected to the local network for the communication with the remote node 160. The remote node 160 may be, for example, a data center or the like disposed at a remote location. The communication nodes 180 may be a router and includes a user-side router and a remote node-side router that analyze information contained in packets that are provided from the user terminal 120 and the remote node 160 to choose appropriate paths and forward packets to the remote node 160 and the user terminal 120, respectively. Hereinafter, these user-side router and remote node-side router are integrally referred to as a router 180. Furthermore, the router 180, as will be explained in detail with reference to FIG. 2, incorporates therein a traffic optimization apparatus that is configured to expand and apply the WAN optimization technique, which is exclusively applied to business users in an enterprise, to the smart devices of common users.

By way of example, it is assumed that a user connected to a local network uses the user terminal 120 such as a smart device to view in real time an online lecture provided from the remote node 160 over a WAN link. The online lecture serves as a real-time multimedia streaming service and essentially has a feature requiring a high rate bandwidth, a low latency and a low jitter. However, as described above, a WAN system has an extremely limited bandwidth that can be served in its characteristic compared to the LAN system and also exhibits a high latency. Therefore, the WAN system cannot meet the quality required in the online lecture service. Accordingly, the user of the user terminal 120 who views the online lecture over the WAN link 140 without having the WAN optimization technique frequently experiences a phenomenon that a video becomes slow or broken due to a lack of bandwidth and a high latency. However, in accordance with an embodiment of the present invention, the router 180 at the remote node-side performs an optimization on packets provided from the remote node 160 before transmitting data of the packets to the user terminal 120 over the WAN link 140. Therefore, a large amount of traffic of the online lecture can be reduced into a low volume of traffic through a caching technology and a compression technology and a user will receive the online lecture with a low latency by a protocol optimization and bandwidth management techniques. Ultimately, it is possible to receive the online lecture service without the occurrence of the slowness or breakage of the video, which results in raising a satisfaction of quality.

In addition, the existing appliance-based WAN optimization technique has a limitation that additional equipment such as a WAN appliance needs be installed in a user terminal such as a smart device, but the embodiment of the present invention has an advantage that a WAN optimization can be accomplished without installing the additional equipment in the user terminal.

FIG. 2 is a block diagram of the traffic optimization apparatus mounted on the communication nodes shown in FIG. 1 in accordance with an embodiment of the present invention. In FIG. 2, a thick arrow represents a flow of packets.

The packets produced in the remote node 160 are provided in a unit of flow to a traffic optimization apparatus 200 in the communication node 180, i.e., a router and become optimized before providing to the user terminal 120 over the WAN link 140, or vice versa. That is, similarly, the packets produced in the user terminal 120 are provided in a unit of flow to the traffic optimization apparatus 200 in the router 180 and become optimized before providing to the remote node 160 over the WAN link 140.

The term ‘flow’ used herein refers to a flow of data packets that travel between a transmitting side and a receiving side along a given network path.

As illustrated in FIG. 2, the traffic optimization apparatus 200 includes a packet processing module 210, a flow information table 230 and an optimization module 250.

The packet processing module 210 includes a packet classification unit 212 that classifies packets incoming in a unit of flow and a packet transmission unit 214 that sends packets to a destination. The packet classification unit 212 inspects a header of the packets to classify the packets and may be implemented with a DPI (Deep Packet Inspection) unit. The packet classification unit 212 is configured to identify a flow based on 5-tuple as well as an application based on a layer-7 in detail. In this regard, the 5-tuple includes a set of source IP address, destination IP address, source port number, destination port number, and protocol type in use.

The flow information table 230 contains information on packet flows that are managed in the router 180, for example, in the form of a table, as illustrated in FIG. 2.

The flow information includes a flow identification ID (Flow #) to identify the packet flow, an application service type applied to the packet and an optimization option about optimization techniques of kinds that can be applied to the packet. The service type may include VoIP, VoD, File, or the like. The optimization techniques may include an OC (Object Caching), BC (Byte Caching), CP (Compression), BM (Bandwidth Management), protocol optimization and others. The optimization option indicates that one or two or more optimization techniques are selectively applied to the identified packet.

By way of example, it is assumed that a result of inspecting the incoming packet in the packet processing module 210 identifies that the packet belongs to Flow 2. Accordingly, it is identified from the flow information table 230 that the Flow 2 of the packet corresponds to a VoD service type, and it is indicated that the packet having the VoD service type is subjected to the optimization option including the OC (Object Caching), BC (Byte Caching), CP (Compression) and BM (Bandwidth Management).

The optimization module 250 optimizes the identified packet in compliance with the optimization techniques specified in the packet, i.e., the optimization option including a selective combination of the OC (Object Caching), BC (Byte Caching), CP (Compression) and BM (Bandwidth Management). The OC refers to a technique that caches repeated data for the transmission thereof and the BC refers to a technique that transmits reference values in a reference table that have been made beforehand instead of frequently used data. These techniques enable the saving of the use of a WAN bandwidth. The CP technique refers to a technique that compresses data and transmits the compressed data to save the use of a WAN bandwidth. The PO (Protocol Optimization) refers to a technique that minimizes messages such as SYN, ACK and the like that are frequently occurring and raises a valid data transmission to lower a transmission delay while raising a network usage efficiency. The BM refers to a technique that guarantees the bandwidth required in service.

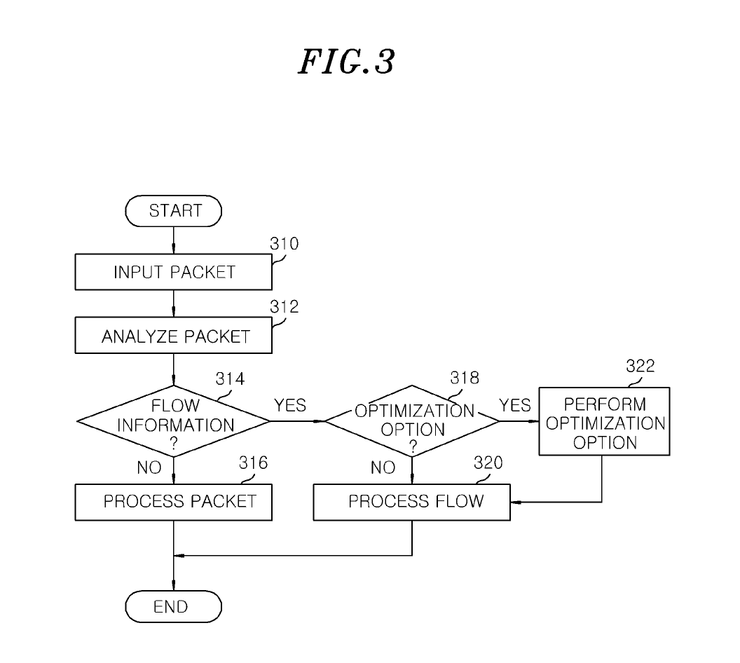

FIG. 3 is a flowchart illustrating a method for optimizing incoming packets in the traffic optimization apparatus in accordance with an embodiment of the present invention.

First, in operation 310, a packet is input to the traffic optimization apparatus 200 in the router 180 in a unit of flow. In operation 312, the packet processing module 210 analyzes the packet so that information on the flow to which the packet belongs can be acquired from the flow information table 230.

Next, in operation 314, through the pack analysis of the packet processing module 210, it is determined whether the packet is identified in the flow information table 230. In other words, it is determined whether the packet corresponds to which flow identification ID in the flow information table 230. As a result of the determination in the operation 314, it is determined that the packet is not identified in the flow information table 230, the method goes to operation 316. In operation 316, the packet processing module 210 processes the packet using a typical packet processing method. Meanwhile, as a result of the determination in the operation 314, it is determined that the packet is identified in the flow information table 230, the method advances to operation 318. In operation 318, the packet processing module 210 determines whether an optimization option specified by the service type of the identified packet is present. When the optimization option is null, the method proceeds to operation 320 where the packet processing module 210 allows the packet to be forwarded to its destination via the packet transmission unit 214 without applying any optimization option.

However, when it is determined that there is the optimization option, the method goes to operation 322. In operation 322, the packet processing module 210 forwards the packet to the optimization module 250, and the optimization module 250 applies the optimization option to the packet. For example, a packet Flow 2 is a kind of VoD service and is subjected to an optimization option including a set of the OC, BC, CP and BM. Subsequently, the packet, which has been optimized, will be transmitted to the user terminal 120 over the WAN link 140 via an output port defined in the Flow 2.

As described above, as compared with the appliance-based optimization technique to provide only the WAN optimization, the traffic optimization apparatus and method having a traffic optimization solution of the embodiment of the present invention has advantages that it is possible to provide the WAN optimization as well as an integrated solution that is further strengthened such as delicate bandwidth management and QoS, viability security, resource virtualization, management of the network state, enhanced security vulnerabilities against DDoS attacks, through different functionalities provided from the router.

Also, unlike an existing appliance-based solution which was developed with the goal of an enterprise network market, the traffic optimization apparatus and method of the embodiment of the present invention has a considerable significance in terms of factors that a target market is extremely large because of aiming at a user market of general smart devices and that the WAN optimization function is provided to the user terminals without installing the separate additional equipment.

While the description of the present invention has been made to the exemplary embodiments, various changes and modifications may be made without departing from the scope of the invention. Therefore, the scope of the present invention should be defined by the appended claims rather than by the foregoing embodiments.

What is claimed is:

1. An apparatus for optimizing traffic of packets produced in a user terminal and a remote node with a WAN link between the user terminal and the remote node, the apparatus comprising:
a flow information table configured to have identification information about the respective packets that are managed in the apparatus and specify an optimization option to be optionally applied to the respective packets;
a packet processing module configured to analyze the packets to determine whether the respective packets are identified in the flow information table; and
an optimization module configured to optimize the packets in compliance with the optimization option specified in the respective identified packets.

2. The method of claim 1, wherein the packet processing module comprises a packet classification unit configured to inspect a header of the packets to classify the packets.

3. The method of claim 2, wherein the packet classification unit comprises a DPI (Deep Packet Inspection) unit and is configured to identify a flow based on at least 5-tuple.

4. The method of claim 1, wherein the flow information table is configured to contain information on the flow managed by the apparatus in the form of a table; and
wherein the information on the flow comprises information about a flow identification ID, a service type of the packets and an optimization option that is applied to the packets.

5. The method of claim 4, wherein the optimization option comprises an OC (Object Caching), BC (Byte Caching), CP (Compression), BM (Bandwidth Management) or a combination thereof.

6. The method of claim 1, wherein the optimization apparatus is incorporated into a router.

7. A method for optimizing traffic of packets produced in a user terminal and a remote node with a WAN link between the user terminal and the remote node, the method comprising:
analyzing the packets to determine whether the packets are managed in the optimization apparatus; and
determining, when it is determined that the packets are managed by the optimization apparatus, whether an optimization option is specified in the managed packets; and
optimizing the packets in compliance with the optimization option specified in the managed packet.

8. The method of claim 7, wherein the packets are analyzed by a DPI (Deep Packet Inspection) scheme.

9. The method of claim 8, wherein the DPI scheme is configured to identify a flow based on at least 5-tuple.

10. The method of claim 7, wherein said optimizing the packets comprises:
applying an OC (Object Caching), BC (Byte Caching), CP (Compression), BM (Bandwidth Management) or a combination thereof to the managed packets.
